(19) United States
(12) Patent Application Publication
(10) Pub. No.: US 2009/0066786 A1
(43) Pub. Date: Mar. 12, 2009

(54) Depth Illusion Digital Imaging

(75) Inventor: Benzion Landa, Nes Ziona (IL)

Correspondence Address: Martin D. Moynihan;PRTSI, P.O. Box 16446, Arlington, VA, 22215, US

(73) Assignee: HumanEyes Technologies Ltd., Jerusalem (IL)

(21) Appl. No.: 11/918,232

(22) PCT Filed: Apr. 11, 2006
(86) PCT No.: PCT/IB2006/051114

§ 371 Date: Oct. 11, 2007

Related U.S. Application Data
(60) Provisional application No. 60/570,087, filed on May 10, 2004.

(51) Int. Cl. H04N 13/04

(52) U.S. Cl. 348/54; 348/E13.001

(57) ABSTRACT

A method of generating a visual display of a scene having a desired illusion of depth comprising: generating a sequence of display images of the scene; setting velocities of features in the scene to generate non-perspective distortions of the scene in the display images; and sequentially displaying the display images.

### RELATED APPLICATIONS

This application claims the benefit under 35 U.S.C. 119(e) of U.S. Provisional application 60/670,087, filed on Apr. 11, 2005, entitled “Depth Illusion Digital Imaging”, the disclosure of which is incorporated herein by reference.

### FIELD OF THE INVENTION

The invention relates to methods of generating a visual display of a scene that provides a perception of depth and methods for controlling a degree of the depth perception.

### BACKGROUND OF THE INVENTION

Human stereo vision relies on primary or physiological and secondary or psychological, sometimes called pictorial, depth cues to interpret three-dimensional information from a scene received on the two-dimensional surface of the eye or retina. Whereas some physiological cues, such as accommodation, or an amount of change of lens shape that the eyes provide to focus on an object, may be provided by monocular vision, i.e. by a single eye, many physiological depth cues are binocular cues that are a function of a person having two eyes. Binocular cues include convergence, or the angle through which the eyes are rotated to focus on an object, and retinal disparity, which refers to a difference between images of a same scene that the left and right eyes see because of their different positions.

Both eyes are not in general required to provide psychological depth cues and each of the eyes working alone may provide these cues. Psychological depth cues are used to explain depth perception a person experiences when looking at photos and paintings and include relative size, linear perspective, height of objects above the line of sight, interposition, shading, shadow, relative brightness, color (chromostereopsis), and atmospheric attenuation. These psychological cues are widely used in terrain representations to provide a sense of depth. Motion cues are often classified as a psychological cue. However, since they produce changes in relative displacements of retinal images of objects at different distances, motion cues actually produce physiological responses that convey three-dimensional information. Many of the psychological cues can be combined with physiological cues to produce enhanced three-dimensional effects.

Various three-dimensional stereoscopic display technologies exist for conveying either physiological or psychological cues that impart depth information from, for example, two-dimensional paper, video and computer system images. As noted above, printed representations commonly use psychological cues. However, anaglyph prints rely on the physical separation of left and right images based on splitting the color spectrum into red and green/blue components and masking the images so that they are “routed” to the appropriate eyes to render the three-dimensional scene. Film products may include polarized films for separation and allow color images to be printed. Films still require glasses, commonly with horizontal polarization for one eye and vertical polarization for the other to convey separate images. Video and computer systems use both anaglyph and polarization and these methods are commonly implemented in softcopy photogrammetry systems to accomplish the left/right separation. These systems also allow motion and other specialized approaches with technologies such as lenticular and holographic displays to enhance the stereo image separation.

Autostereoscopic methods of three-dimensional display are based on a variety of concepts and methods and do not require a person to wear 3D glasses to achieve synthesis of depth information in the human eye-brain system. Autostereoscopic displays rely on stereoscopic viewing of right and left images or alternating pairs of images and include lenticular displays, parallax barrier displays as well as displays based on motion parallax.

An article “Mapping Perceived Depth To Regions Of Interest In Stereoscopic Images”; Nick Holliman; Stereoscopic Displays and Virtual Reality Systems XI, Proceedings of SPIE-IS&T Electronic Imaging, SPIE Vol. 5291, 2004, ISBN 0-8194-5194 describes a method of mapping a defined region of interest (ROI) in scene depth to a stereoscopic 3D display so that the ROI has improved perceived depth compared to other regions of the scene. For a given dynamic depth range in the stereoscopic display, the ROI is mapped onto a larger proportion of the display than other regions of the scene.

U.S. Pat. Nos. 6,532,036, 6,665,003, 6,795,109, 6,831,677, all to Peleg et al, and 6,795,575 to Robinson, et al. the disclosures of which are incorporated herein by reference, describe methods of generating left and right mosaic images of a scene suitable for display as stereoscopic right-left image pairs to provide an observer of the mosaic images with a sense of depth. U.S. patent application Ser. No. 09/861,859 to Peleg et al, the disclosure of which is incorporated herein by reference, describes an alternate method of generating sense of depth in which images characterized by different disparities are displayed sufficiently rapidly and so that both eyes see the same images substantially simultaneously. The method does not employ right and left image separation or masking.

U.S. patent application 60/661,907 entitled “Depth Illusion Digital Imaging” filed on Mar. 16, 2005, by some of the same inventors as the present application, the disclosure of which is incorporated herein by reference, describes methods and apparatus for generating a plurality of “display images” of a scene, which when displayed sequentially to an observer without left-right masking, provides a display of the scene having a desired perception of depth.

### SUMMARY OF THE INVENTION

An aspect of some embodiments of the invention relates to providing methods and apparatus for generating a plurality of “display images” of a scene, which when displayed sequentially and sufficiently rapidly to an observer without left-right masking provides a display of the scene having a desired perception of depth.

An aspect of some embodiments of the invention relates to providing methods for controlling the perception of depth in the displayed scene. In some embodiments of the invention, the methods are used to enhance a perception of depth. In some embodiments of the invention, the methods are used to reduce a perception of depth.

An aspect of some embodiments of the invention relates to controlling velocity of features in a scene or the focal length at which the features are imaged independent of velocities or imager focal lengths of other features in the scene to generate relative motion of features that provides an enhanced perception of depth. In some embodiments of the invention, controlling velocity of features is used to reduce a perception of depth.

The present inventors have discovered that, when a scene containing certain depth cues is presented on an ordinary two-dimensional display (such as a computer display or television screen), depth-enhanced images (“3D” images) can be perceived by the viewer.

The inventors have further discovered that the nature of the depth cues that appear to induce or enhance the perceived depth perception are preferably related to the nature in which the brain integrates the two disparate images received from the left and right eye when viewing a true three dimensional scene (“stereopsis”). Specifically, the images that are viewed by each eye separately, though parallax-displaced from one another, are both normal “perspective” views, little different from those captured by an optical camera. However, stereopsis creates a new single image which the brain “sees”, which differs significantly from the normal perspective views as seen by each eye. In fact, the single integrated image which the brain perceives is significantly distorted in several important respects compared to the normal perspective view seen by each eye.

For example, parallel lines, such as railway tracks, that run from the viewer to the horizon, when seen through a single eye, appear to converge at the horizon. However, when viewed stereoscopically, the brain perceives the tracks to be “more parallel”—i.e. less convergent—with the distance between the tracks appearing narrower in the foreground and wider in the distance, compared to the perspective view seen by either eye alone. In other words, stereopsis creates a shrinking of near objects and an enlargement of distant objects, in which “near” and “distant” are relative to the plane of one's focus.

While the effects of changing the size of near and far objects on 3D perception is relatively limited, when the relationship of the objects of the image in a sequence of images is distorted in a manner reminiscent of stereopsis, such that distant objects move faster compared to the relative velocity of nearer objects, the resultant scene can be used in a motion sequence to induce the perception of depth-enhanced images (i.e. contains depth cues).

By “motion sequence” we mean that the depth-cued scene, as described above, is presented in a sequence of still frames—such as a movie or video sequence—in which the angle of view of the scene progressively changes (i.e. the “viewer” or the “camera” is moving with respect to at least a part of the scene). Positions from which a scene is imaged, in accordance with embodiments of the invention, may lie along any of many different forms of curves. The positions may move laterally with respect to the scene and/or execute zoom in and/or zoom out motion with respect to the scene. For example, in some embodiments of the invention, the positions lie along a three-dimensional non planar curve, which curve requires a function of three spatial coordinates relative to the scene to be properly described. In some embodiments of the invention, the positions lie along a planar curve. In some embodiments of the invention, the positions lie along a straight line.

It is noted that terms used herein to denote real features of a real camera, such as optic center, optic axis and focal plane, where appropriate, refer to corresponding features of a computer graphics camera.

Without being bound by any theory, it appears that the combination of depth-cuing and relative motion creates images that are reminiscent enough to the stereopsis-induced images which the brain sees when viewing true three-dimensional images that the brain recognizes the depth-cued scene as a true three dimensional image—though it is presented on an ordinary two dimensional display.

Of course it is not possible to capture a scene—using an optical camera—in such a way as to embody the necessary perspective distortions, described above, to effect said depth-cued imaging. It is, however, possible, in accordance with this invention, to create such depth cues artificially, either manually, or, preferably, using a computer. When using a computer to create such images, it is possible to use algorithms that automatically relegate certain image planes—and certain viewing angles—to specific treatment (such as enlargement or reduction).

For example, objects at the desired focal distance (or center of attention) can be deemed to be viewed through a virtual lens of a particular focal length, while nearer objects through progressively shorter focal length lenses while more distant objects through progressively longer focal length lenses, making nearer objects smaller and more distant objects larger, the ratio of such focal lengths and enlargements, as well as the aspect ratios of such enlargements, being adjustably determined in advance. Moreover, it is possible—and desirable—to also alter the focal length of the virtual lens not just as a function of distance from the camera (or distance in front of or behind the focal plane) but also as a function of the viewing angle, so that images in the peripheral areas of vision do not necessarily have the same degree of distortion as those in the center of view. It is noted that this change in focal length distorts the relative motion of near and far objects and thus distorts the image between frames of the motion sequence.

In another embodiment of this invention, objects at the desired focal distance (or center of attention) can be deemed to be viewed through a virtual lens of a particular focal length, while nearer objects through progressively shorter focal length lenses while more distant objects through progressively longer focal length lenses, while maintaining the size of the objects at each plane in their correct respective proportions or dimensions with respect to their distance from the camera. In this instance too, it is possible to alter the focal length of the virtual lens not just as a function of distance from the camera (or distance in front of or behind a focal plane) but also as a function of the viewing angle, so that images in the peripheral areas of vision are not necessarily viewed through the same focal length lens as those in the center of view.

In each of these aforementioned embodiments, the focal length differences alter the relative motion of near and far objects with respect to the rate of camera motion. In the aforementioned embodiments, the virtual lenses of different focal lengths may each be of different cameras located coaxially with respect to the optical of the lenses and may, preferably, be co-located at the same point or the same distance from any point in the scene. In other words, the multiple virtual cameras may be regarded as a single camera with multiple lenses, each of different focal length, each associated with a designated plane of the scene. This method lends itself particularly well to the automated or semi-automated generation of computer images in which each camera lens automatically captures the appropriate plane of the virtual scene through all of the required camera motions. In some embodiments of the invention, the lenses (and optionally the imaging plane) for the various focal length lenses are spaced along a same optical axis. In some embodiments of the invention the focal lengths of the virtual lenses change as a function of their location relative to the scene or to a particular feature or features in the scene.

The methods of this invention are especially useful for computer “manipulated” images which were originally captured by a camera, or for images that are entirely computer generated, such as animated films or computer games, or for combinations thereof.

In a second type of exemplary manipulation of images in accordance with an aspect of the invention, the relative motion of elements in a scene is varied as a function of their depth. In one embodiment of the invention, a computer-generated (or at least partly computer generated or computer manipulated) video sequence of a scene is created in which the camera moves in any direction or combination of directions or other motion (horizontal, vertical, diagonal, rotational, zoom or other) with respect to at least one element in the scene. The relative motion of other elements in the scene are such that at least some of those other elements, whether nearer or more distant from the camera than the first element, move at a higher rate of relative motion than their respective distances from the first element would dictate if the objects of the scene were in fixed relative positions to one another.

By way of illustration, assume a computer generated scene comprising a relatively stationary child, a tree in the background and a ball in the foreground and that the child's parent is photographing the scene from a moving vehicle with a video camera. As the vehicle moves, the parent aims the camera so that the child remains in the center of the camera's field of view and acquires thereby a sequence of camera images of the scene with the child substantially at the center of the images. Whereas in each of the images, the child is substantially in the center of the scene, because of motion parallax, when viewing a video sequence of the images, the tree in the background and the ball in the foreground move in opposite directions relative to the child. The motion parallax imparts a modicum of depth to the video sequence. However, because the images in the video sequence are two-dimensional images, binocular cues that provide a sense of depth when viewing the actual scene are missing from the video sequence. As a result, the video sequence tends to appear flat relative to the real scene and suffer from a loss of “vitality”.

In accordance with an embodiment of the invention, to provide an enhanced sense of depth and reality to the displayed video sequence, the velocities of the tree and the ball relative to the child (and optionally other features at various distances) are increased. The increased velocities in the display images are greater than velocities of the ball and tree that correspond to, and would be expected from, their distances relative to the child. The increased relative velocities provide an enhanced sense of depth and increased spatial separation between the child, the tree and the ball and consequently a vital 3D depth to the image.

It is noted, that in the unenhanced video sequence acquired by the parent, the ball tree and child are all stationary and their real world relative positions are not changing. The relative motion of the ball and tree in the video sequence images are a result only of the motion of the parent during which he or she acquired the video sequence. In contrast, the depth enhanced images of the scene, in accordance with an embodiment of the invention, correspond to images of a “real world” in which the tree and ball are moving relative to the child. Thus if the images of the virtual scene being acquired were viewed from above, the relative positions of the objects would move during the video sequence (e.g., between images).

It will be appreciated that in the case of normal perspective views of a scene, whether filmed with a camera or generated by computer, the relative positions of inanimate elements of the scene do not change with camera motion and therefore the radius of a circle defined by those elements does not change, irrespective of such camera motion. Though not wishing to be bound by any particular example or theory, the inventors believe that it is this exaggerated relative motion of background or foreground (or middleground) elements that creates the enhanced sense of depth perception of video sequences produced in accordance with the invention.

Though the aforementioned example contains only three objects, the scope of the invention contemplates an unlimited number of objects or elements. For instance, in the aforementioned example, the same rules of relative motion could be applied to each blade of grass on the lawn—or to any or all other objects or elements in any scene. In fact, every pixel in a scene may be designated a particular relative rate of motion as a function of its nominal distance from the camera or from another reference point. Moreover said relative motion need not be linear across the entire field of view (for example, it may be more pronounced in the center of the frame and less pronounced in the peripheral regions, or vice versa).

It has been further found that, while the illusion of depth perception contemplated by this invention is enhanced when there are a substantial number of elements at varying depths in the scene, there need not necessarily be both background and foreground motion Preferably, that the relative motion of at least some of those elements that do move in the scene conform with the aforementioned changing radius rule.

It is further contemplated, in accordance with one embodiment of this invention, that the relative motion of each of the elements and/or objects in a scene is automatically or semi-automatically controlled by a computer program or algorithm.

It is noted that changing velocities of features in a scene, in accordance with an embodiment of the invention, does not necessarily entail changes in distance of the features relative to each other in the scene or changes in their scale. Changes in velocities can be decoupled from changes in distances and scale, though they may be performed in combination with and in coordination with such changes.

In general, by increasing or decreasing a velocity of a more distant feature in a motion sequence relative to a velocity that corresponds to its distance from a nearer feature in the sequence, an impression of depth difference between the features is respectively increased or decreased.

In some embodiments of the invention, the unexpected changes in velocities are configured to generate distortions in a scene that vary in time and lend the scene a seeming measure of plasticity that cannot in general be reproduced by conventional perspective imaging. For example, normal perspective vision and perspective projection map straight lines in a three dimensional scene into straight lines. Velocity changes in accordance with an embodiment of the invention on the other hand often map straight lines into curved lines, which may vary in time during a presentation of a sequence of display images. The inventors have found that such challenges to the eye-brain vision system can be effective in stimulating the brain to generate a relatively strong enhanced sense of depth.

Any of various methods in accordance with embodiments of the invention, such as those discussed below, may be used to independently adjust velocities of features in a scene and generate a motion sequence of display images of the scene. In some embodiments, a scene may be partitioned into layers, each of which is located at a different depth in the scene.

The layers are not necessarily flat and for example, in some embodiments of the invention the layers may be curved and have regions of different thickness. In some embodiments of the invention the layers are spherical or have a spherical region. Optionally, the layers are cylindrical or have a cylindrical region. Optionally, the layers are planar.

At least one layer is assigned a velocity or is viewed through a particular focal length lens, such that stationary features located in the layer move relative to other stationary features in the scene to generate a desired sense of depth in the scene in accordance with an embodiment of the invention. The layers are processed, for example using a computer, to image the scene in the motion sequence display so that at different times in the sequence, i.e. times at which the display images are displayed, the features in the at least one layer are displaced from other features in the scene as a function of its assigned velocity or focal length of lens through which it is viewed.

Thicknesses of the layers, into which a scene is partitioned in accordance with an embodiment of the invention may vary. Optionally, each layer has a uniform thickness. In some embodiments of the invention, thickness of a layer may vary. For example, in regions for which it is desired that velocity be a relatively smooth or fine function of depth, layers are optionally relatively thin. In other regions for which velocity may be allowed to be a coarse function of depth layers are optionally thick. In some embodiments of the invention layers approach zero thickness and velocity of features in a scene, or the focal length through which they are viewed become a smooth function of depth.

In accordance with an embodiment of the invention, to increase the velocity of a feature in a display image of a scene, the distance from which the feature is imaged for the display image is decreased and/or the focal length at which the feature is imaged is increased. To decrease the apparent velocity of a feature in the scene, the distance from which the feature is imaged is increased and/or the focal length at which the feature is imaged is decreased. By increasing the apparent velocity of a farther feature in the scene relative to a nearer feature, parallax between the features and apparent difference in depth is increased. Similarly, by decreasing the apparent velocity of a farther object in the scene relative to a nearer feature, parallax between the features and apparent difference in depth is decreased.

It is believed that the greater the number of layers or focal lengths used (i.e., the more continuous the changes in the scene) the greater and more lifelike the three dimensional effect. Thus, to the extent possible, considering the limits of computation time, etc., the number of layers should be increased and the focal length change should be as continuous as possible.

An aspect of some embodiments of the invention relates to generating depth cues in display images of a scene by changing the scale of features in the scene.

The inventors have determined that to enhance depth perception it can be advantageous to accompany changes in characteristics of features of a scene intended to generate depth cues by scale changes in the features. In particular, the inventors have found that scale changes of features that appear counterintuitive may be advantageous in supporting depth cues. For example, whereas features in an image of a scene are proportional to their depth, with farther features smaller and nearer features larger, the inventors have determined that in fostering depth perception it can be advantageous to depart from scaling features proportional to their intended depths.

In particular, it can be advantageous in fostering a sense of greater depth in a scene, in accordance with an embodiment of the invention, to scale features that are farther from a center of the scene larger than would be expected from their depths. Similarly, it can be advantageous to scale nearer features in the scene smaller than in proportion to their intended depths. The inventors feel that this effect may be related to the phenomenon of constancy of perceived size, wherein objects of known size are perceived as having constant size irrespective of their distance.

For example, as a first person walks away from a second person, even though the images of the first person on the retinas of the second person's eyes are actually getting smaller as the first person recedes from the second person, the second person does not in general have an impression that the first person is shrinking. Similarly, when looking along receding railway tracks, even though the distance between the tracks in the retinal image of a nearer portion of the tracks is larger than the distance between the tracks in the retinal image of a farther portion of the tracks, the tracks are perceived as parallel. That is, the distance between the tracks is not perceived as getting smaller with distance. While not being limited by any particular theory or interpretation as to reasons for effects of scaling in accordance with an embodiment of the invention in generating and/or supporting depth cuing, it appears that scaling may ascribe its effect to concomitance with size constancy.

Methods in accordance with embodiments of the present invention are optionally encoded in any of various computer accessible storage medium, such as a floppy disk, CD, flash memory or an ASIC for use in generating and/or displaying display images that provide enhanced depth perception. Methods and apparatus in accordance with embodiments of the present invention may be used to enhance depth perception for many different and varied applications and two dimensional visual presentation formats. For example, the methods may be used to enhance depth perception for computer game images, animated movies, visual advertising and video training.

There is thus provided, in accordance with an embodiment of the invention, a method of generating a visual display of a scene having a desired illusion of depth comprising:

generating a sequence of display images of the scene;

setting velocities of features in the scene to generate non-perspective distortions of the scene in the display images; and sequentially displaying the display images.

There is further provided, in accordance with an embodiment of the invention, a method of generating a visual display of a scene having an enhanced illusion of depth, comprising:

generating a sequence of images of the scene, each image being acquired for a different position relative to at least some of the features in the scene; and sequentially displaying the display images,

wherein generating said sequence includes:

setting positions of features in the scene in a systematic manner from image to image to generate non-perspective distortions of the images to provide an enhanced perception of depth to the sequence of images.

There is further provided, in accordance with an embodiment of the invention a method of generating a visual display of a scene having an enhanced illusion of depth, comprising:

generating a sequence of display images of the scene, each image being acquired by a virtual camera from a different position relative to at least some of the features in the scene; and sequentially displaying the display images,

wherein generating said sequence includes providing at least one feature in the scene with a velocity that generates relative motion between features, which in the scene are nominally stationary relative to each other, wherein a velocity provided to a feature of the at least one feature is a function of the features depth in the scene relative to the camera.

Optionally, the method includes generating a visual display according to claim 3 wherein the virtual camera positions lie along a non-planar three dimensional trajectory. Alternatively, the virtual camera positions lie along a planar trajectory. Optionally, the virtual camera positions lie along a linear trajectory.

Optionally, some of the positions are closer to the scene than others. Optionally, at least two positions are displaced from each other laterally relative to the scene.

In an embodiment of the invention, features at different depths relative to the camera are imaged at different focal lengths.

In an embodiment of the invention, the scene is partitioned into layers. Optionally, a same velocity is set for features in a same layer. Optionally, different velocities are set for different layers.

In an embodiment of the invention, at least one position of the virtual camera, the camera images different layers from different locations along the camera's optic axis.

In an embodiment of the invention, features that are closer to the camera are provided with a velocity in a first direction, features at an intermediate distance are stationary and wherein features at a farther distance are provided with a velocity in a second direction generally opposite to said first direction. Alternatively, features that are closer to the camera are provided with a first velocity in a first direction, features at an intermediate distance are provided with a second velocity smaller than said first velocity in said first direction and features at very large distances are stationary. Alternatively, features that are close to the camera are stationary, features at an intermediate distance are provided with a first velocity in a first direction and features at a farther distance are provided with a second velocity greater than said first velocity in said first direction. Optionally, the first direction is generally parallel to a direction of motion between said different positions.

In an embodiment of the invention, moving features are provided with an additional velocity or change in position consistent with the change provided to correspondingly placed stationary objects.

There is further provided, in accordance with an embodiment of the invention, a method of generating a visual display of a scene having an enhanced illusion of depth, comprising:

generating a sequence of display images of the scene, each display image being acquired by a virtual camera from a different position relative to at least some of the scene's features; and

sequentially displaying the display images,

wherein a focal length at which the virtual camera images a feature in the scene is a function of the distance of the feature from the camera.

Optionally, some features that are further from the camera are imaged with a focal length that is greater than a focal length used to image features that are relatively nearer to the camera.

Optionally, the method includes displaying the display images so that may be viewed by both eyes of a viewer.

There is further provided, according to an embodiment of the invention, a visual display image generated in accordance with any of the preceding claims.

There is further provided, in accordance with an embodiment of the invention, a sequence of visual display images comprising a visual display image in accordance with the invention.

There is further provided, in accordance with an embodiment of the invention, a sequence of visual images in which an imaging position moves between images and in which stationary objects move with respect to each other between images dependent on a distance between the objects and imaging position.

There is further provided, in accordance with an embodiment of the invention, a computer accessible storage medium encoded with a method or an image or sequence of visual images in accordance with the invention.

### BRIEF DESCRIPTION OF THE DRAWINGS

Non-limiting examples of embodiments of the present invention are described below with reference to figures attached hereto, which are listed following this paragraph. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1A schematically shows the scene comprising a ball a girl and a tree discussed in the summary being imaged to provide a motion sequence of display images in accordance with prior art;

FIG. 1B schematically shows the scene shown in FIG. 1A being imaged to provide a motion sequence in accordance with an embodiment of the present invention;

FIG. 1C schematically shows sequences of display images generated in accordance with prior art as shown in FIG. 1 and, as illustrated in FIG. 1B, in accordance with the present invention;

FIG. 2 schematically shows partitioning a scene into layers and assigning velocities to the layers, in accordance with an embodiment of the present invention;

FIGS. 3A-3E schematically illustrate distortions in versions of a scene used to generate display images of the scene, in accordance with an embodiment of the present invention;

FIG. 4 shows a plan view of distortions shown in FIGS. 3A-3E, in accordance with an embodiment of the present invention;

FIG. 5A schematically illustrates generating display images by imaging different features of a scene at different focal lengths; and

FIG. 5B schematically shows sequences of display images generated in accordance with prior art as shown in FIG. 1 and, as illustrated in FIG. 5A, in accordance with the present invention.

### DETAILED DESCRIPTION OF EMBODIMENTS OF THE INVENTION

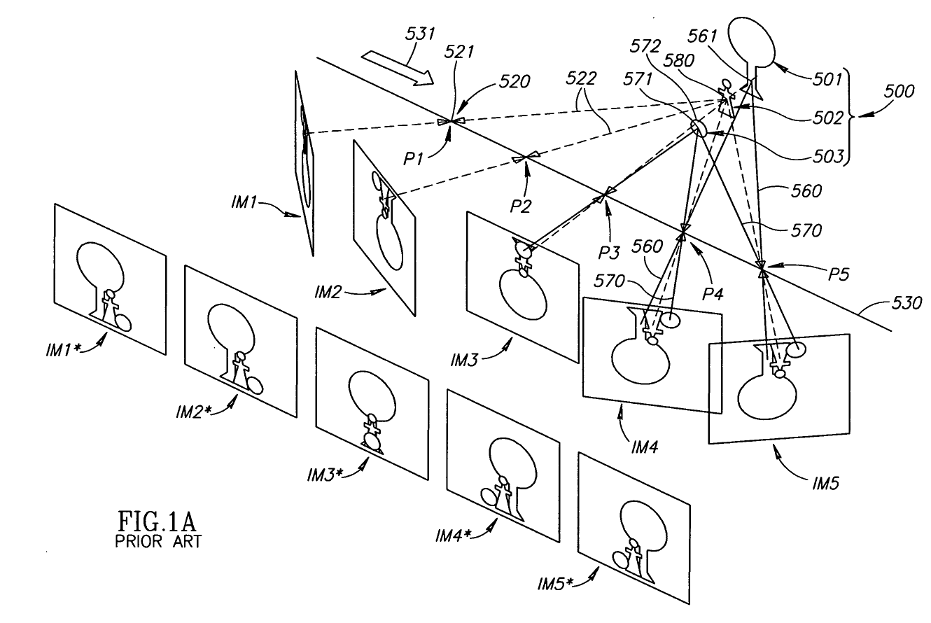

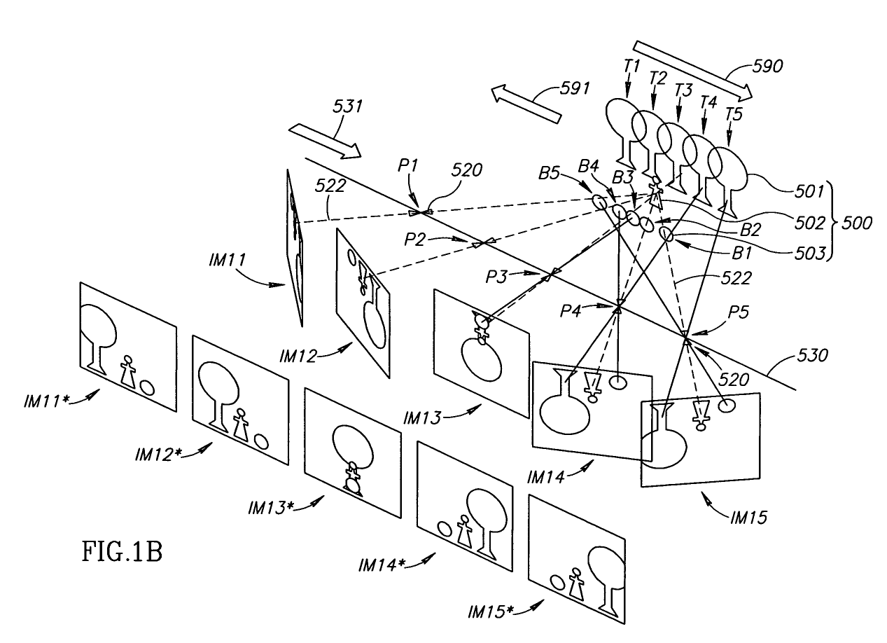

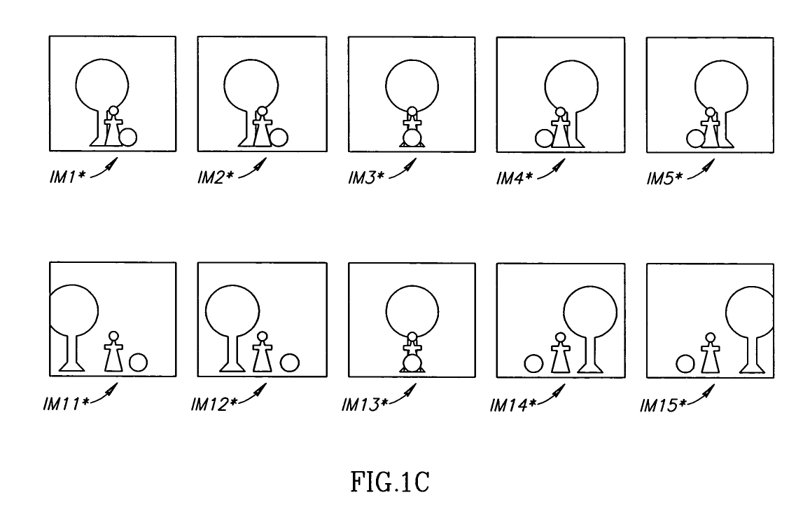

FIG. 1A schematically shows a scene 500 comprising a tree 501, a girl 502 in front of the tree and a ball 503 in front of the girl being imaged by a moving camera represented by an hourglass icon 520 in accordance with prior art. A waist 521 of the hourglass icon represents an optic center of camera 520 and a dashed line 522 represents the optic axis of the camera. Optionally, camera 520 is moving along a straight line trajectory 530 at a constant velocity in a direction indicated by a block arrow 531 and acquiring camera images of scene 500 at regular intervals.

By way of example, camera 520 is oriented so that at each of the positions along trajectory 530 at which it acquires images of scene 500, its optic axis intersects girl 502. Camera 520 is schematically shown at five locations P1-P5 along trajectory 530 at which it acquires corresponding display images IM1-IM5 of scene 500 for use in providing a motion sequence of images of the scene. Scene 500 may be an actual scene and camera 520 an actual camera, held for example by a parent of the girl in the scene riding in a car. For convenience of presentation however it is assumed that image 500 is a synthetic image and camera 520 a computer graphics camera that acquires images of scene 500.

Images IM1-IM5 are shown from the back, upside down and reversed from left to right in orientations at which they are acquired by camera 520. Images IM1*-IM5* are images IM1-IM5 respectively as seen by an observer, reversed left to right and right side up relative to the orientations of images IM1-IM5. For some of images IM1-IM5, a ray 560 from a central spot 561 of tree 501 that passes through optic center 521 of camera 520 and is incident on the images indicates locations of an image of the central spot on the images. Similarly, rays 570 indicate locations of images of a central spot 571 of ball 503 for some of images IM1-IM5. A central spot 580 on girl 502 is imaged on all images IM1-IM5 at points on the images intersected by optic axis 522.

For convenience of presentation, at location P3, optic axis 522 passes through central points 561 and 580 of tree 501 and girl 502 and through an uppermost “top” point 572 on the circumference of ball 503 that is directly above center 571 of the ball. Locations P1 and P2 are mirror images of locations P4 and P5 respectively in a plane perpendicular to trajectory 530 that passes through optic center 521 of camera 520 at location P3. At position P3 at which image IM3 is acquired, the images of the ball, girl and tree are layered one on top of the other since at position P3 the girl, the tree and the ball are aligned one behind the other. In images IM1-IM5 because of motion parallax, tree 501 progressively moves from the left of girl 502 to the right of the girl and ball 503 moves progressively from the right to the left of the girl. An amount by which the ball and tree move relative to the girl may provide a modicum of depth perception when images IM1-IM5 are shown in sequence.

FIG. 1B schematically shows scene 500 being imaged to provide display images for a motion sequence of scene 500 that generates an enhanced sense of depth, in accordance with an embodiment of the invention.

As in FIG. 1A, in FIG. 1B camera 520 moves along trajectory 530, and acquires images of scene 500 at positions P1-P5, at each of which positions optic axis 522 intersects girl 502. However, unlike in FIG. 1A, tree 501 and ball 502 are not stationary during imaging by camera 520. Instead tree 501 optionally moves, as indicated by a block arrow 590 from left to right during imaging and optionally ball 503, as indicted by a block arrow 591, moves from right to left during imaging. At positions P1-P5 of camera 520, tree 501 is imaged at corresponding positions T1-T5 respectively and ball 503 at positions B1-B5 respectively. The figures acquired by camera 520 at positions P1-P5 are labeled IM11-IM15 and in their viewing orientations are labeled IM11*-IM15*.

In some embodiments, tree 501 and ball 503 move at constant velocities preferably in a direction parallel to the movement of camera 520. Optionally, they move with varying velocities. By way of example, in FIG. 1B tree 501 moves with a constant velocity and positions T1-T5 are equally spaced. Ball 503 moves with a constant velocity between positions B2-B4. However, between positions B1 and B2 and between positions B4-B5, ball 503 optionally moves with a velocity higher than the velocity at which it moves between positions B2-B4.

The increased velocity of ball 503 between positions B1 and B2 and between B4 and B5 provides for enhanced relative motion between the girl and ball in images acquired at positions relatively far from P3. At positions far from P3, because of the relatively large angles that rays from the ball make with optic axis 522, for a same given velocity at which ball 503 moves, relative motion between the ball and the girl in perspective images IM11 and IM15 is substantially reduced relative to that in images IM12-IM14.

Because of the “artificial” motion of tree 501 and ball 503, in the sequence of images IM11*-IM15*, the tree and the ball move substantially greater distances relative to the girl and with respect to each other than they do in images I1*-I5*. For ease of comparison, images IM1*-IM5* acquired in FIG. 1A and images IM11*-IM15* are shown in FIG. 1C. As a result of the greater relative motion of the tree and ball in images IM118-IM15*, a motion sequence comprising images IM11*-IM15*, in accordance with an embodiment of the invention, exhibits enhanced depth perception in comparison with a corresponding motion sequence comprising images I1*-I5*.

It is noted that the motion of camera 520 along trajectory 530 in FIGS. 1A and 1B is relative to scene 500 and the images acquired at locations P1-P5 could of course be duplicated by maintaining the camera stationary and moving the scene. For the “motionless camera”, the effects of changing velocities of features in scene 500, in accordance with an embodiment of the invention, such as shown in FIG. 1B, can be provided by vector addition of velocities. It is noted that while images according to FIG. 1A can be acquired by a real camera, the images of FIG. 1B can not generally be so acquired. However, the methods of the present invention are suitable for both composite images of real objects and for animations. They could also be used to a limited extent in manipulating real images.

In general, a scene such as scene 500, has more features than just the tree, the girl and the ball and will usually comprise grass, stones, bushes a swing on the tree and possibly a dog, who most probably will find it difficult to remain still during the telling of this story. To maintain reality of scene 500, it is generally advantageous to adjust velocities of features (not shown) in the scene in addition to adjusting the velocities of the tree and the ball.

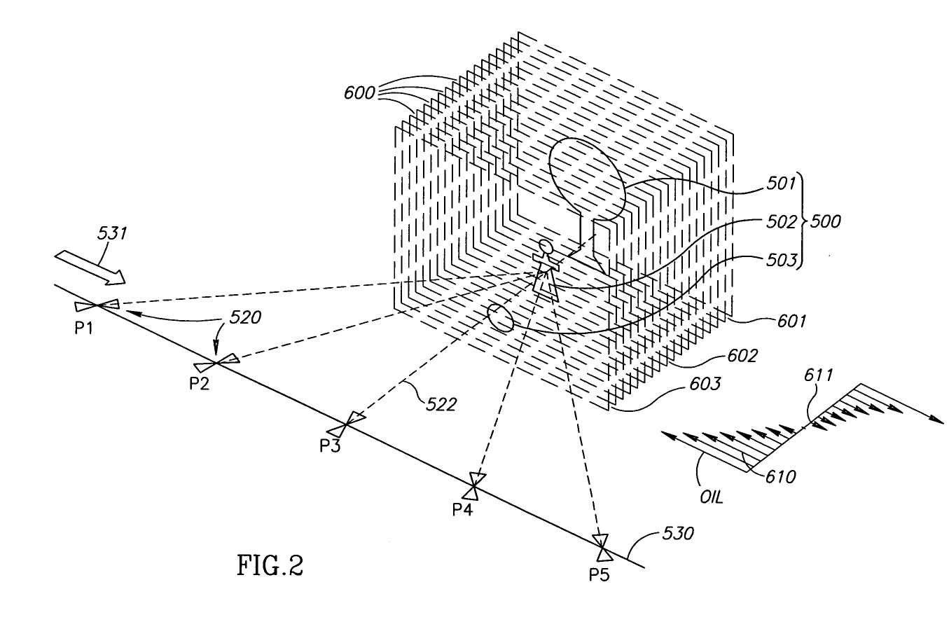

In accordance with an embodiment of the invention, to adjust velocities of additional features in scene 500, the scene is partitioned into layers, each of which is optionally parallel to and located at a different distance from trajectory 530. FIG. 2 schematically shows scene 500 partitioned into a plurality of layers 600 in accordance with an embodiment of the invention. Optionally, layers 600 are planar and have a same uniform thickness.

In accordance with an embodiment of the invention, each layer 600 is provided with a velocity so that there is a relatively smooth change in velocity of features in scene 500 as a function of their respective depths. Layers labeled 601, 602 and 603 comprise tree 501, girl 502 and ball 503 respectively. Arrows 610 arrayed opposite layers 600 along a line 611 schematically indicate velocities assigned to the layers in accordance with an embodiment of the invention. A velocity assigned a given layer 600 is indicated by the arrow 610 opposite the layer. Direction of the arrow schematically indicates direction of the velocity and length of the arrow its magnitude. Layers 601 and 603 comprising tree 501 and ball 503 are assigned velocities in opposite directions and have maximum, not necessarily equal, velocities in their respective directions. Layer 602 comprising girl 502 is assigned zero velocity since camera 520 is assumed to move along trajectory 530 with its orientation adjusted so that optic axis 522 is directed to the girl.

Velocities 610 may be determined, in accordance with embodiments of the invention, in various ways. For example, if Z is a distance of a given layer 600 from trajectory 530 and Z_{O} is distance of girl 502 from the trajectory, magnitude of velocities 610 may be proportional to a power of (Z−Z_{O}), for example, (Z−Z_{O})^{1/2} or (Z−Z_{O})², or an exponential function e_{α|(Z-Zo)|}. Furthermore. velocities 610 are not necessarily constant in time, as measured for example by progress of camera 520 along trajectory 530 and as translated into a display sense of time when images IM11*-IM15* (FIGS. 1B and 1C) are displayed in a motion sequence. For example, as indicted by positions B1-B5 in FIG. 1B, and as noted in the discussion of the figure, ball 503 is not assigned a constant velocity. It is also noted, that whereas in FIG. 2, velocities of features in scene 500 are determined by velocities 610 of the layers 600 in which they are located, which velocities by their nature are discontinuous as boundaries between layers having different velocities, in some embodiments of the invention, velocities of features are continuous functions of depth in a scene. Thus, it is considered desirable to increase the number of layers.

It is noted that other velocity profiles can be used in various embodiments of the invention. For the embodiment shown in FIG. 2, the child is stationary. In accordance with other embodiments of the invention the stationary plane can be virtually any plane between the plane of the camera motion and infinity.

The sense of depth perception generated by a motion sequence of images IM11*-IM15* is not only enhanced by the increased relative velocities of the ball, the girl, the tree and features in layers 600 intervening between them caused by choice of velocities 610. The inventors have determined that the enhanced sense of depth also appears to be engendered by distortions introduced into the sequence of images IM11*-IM15* by the choice of velocities.

For example, the sequence of images acquired of scene 500 are assumed to be of a “real” scene in which tree 501 does not move and by assumption the girl is standing still and the inanimate ball does not move of its own accord. The tree the ball and the girl are assumed to be aligned one behind the other as they are shown in FIG. 1A so that a straight line passes through the central spots 561 and 580 of the tree and the girl and top spot 572 of ball 503. The line optionally coincides with optic axis 522 when camera 520 is located at position P3. In conventional perspective imaging, shown for example in FIG. 1A, this line, as well as all straight lines in scene 500, are mapped into straight lines acquired by camera 520 at all positions of the camera.

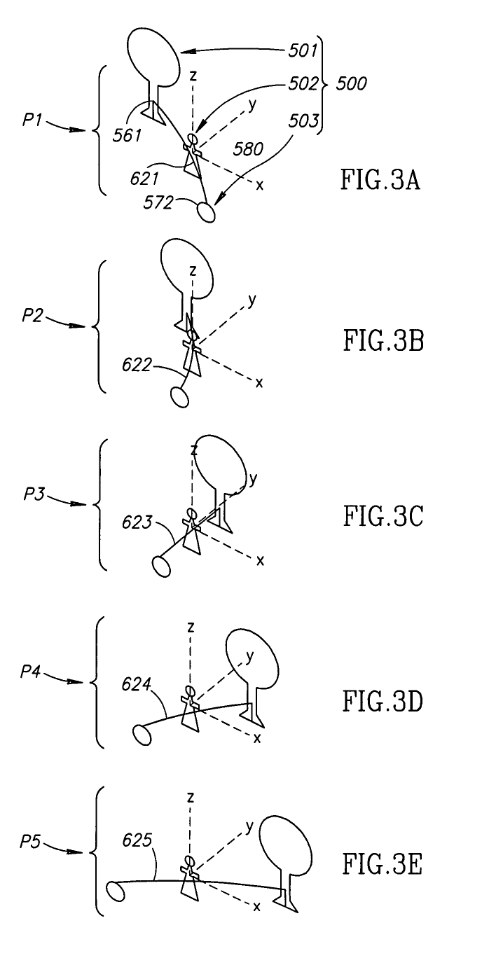

For imaging scene 500 in accordance with an embodiment of the invention however, the velocities assigned to features and/or layers in the scene introduce distortions that remove constraints of perspective imaging and result in straight lines being mapped into curved lines. FIGS. 3A-3E schematically illustrate “perspective breaking” distortions introduced into images IM11*-IM15* by imaging scene 500 using a choice of velocities in accordance with an embodiment of the invention similar to that shown for example in FIG. 1B.

FIGS. 3A-3E show the locations of tree 501 and ball 503 relative to girl 502 for each of the positions P1-P5 (FIG. 1B) of camera 520. An xyz-coordinate system that is stationary with respect to the girl and has its origin at central point 580 of the girl is shown in each of the figures to aid in visualizing the spatial relationships of the tree, girl and ball. Lines 621-625 connect central spots 561, and 580 and top spot 572 in FIGS. 3A-3E and in all the figures each line 621-625 is presumed to pass through the same points of each of the other features in scene 500 whose velocities are adjusted, for example in accordance with FIG. 2. In image 3C line 623 is a straight line, correctly reflecting the assumption that in the “real scene 500” the tree, the girl and the ball are aligned along the y axis of the coordinate system. However, in FIGS. 3A, 3B, 3D and 3E, the velocity changes in accordance with an embodiment of the invention morph the real scene into a distorted scene for which line 623 is morphed into lines 621, 622, 624 and 625 respectively which are no longer straight lines. Similarly almost all other lines that are straight in the real image (FIG. 3C), are morphed into lines that are not straight lines.

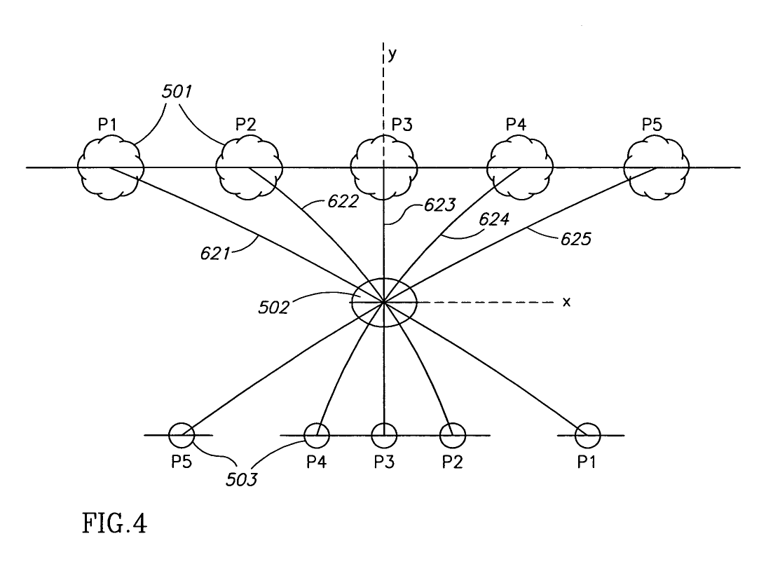

FIG. 4 shows a top view, i.e. as seen from a viewpoint along the z-axis, of the scenes shown in FIGS. 3A-3E superimposed one on top of the other so that the distortions that line 623 undergoes in positions P1, P2, P3 and P4 are readily seen. Each of the positions of tree 501 and ball 503 is labeled with a position of camera 520 to which the position of the tree and the ball correspond. Since the position of girl 502 does not change, it is not labeled with any of the camera positions.

Not only are straight lines not mapped into straight lines as in conventional perspective imaging, but as shown in FIGS. 3A-3E and FIG. 4, the generally curved lines into which the straight lines are imaged, change with time. Images IM11*-IM15*(FIG. 1B, FIG. 1C) record the distortions and therefore do not provide a sequence of images that correspond to a real scene. Instead the images record a scene that, in accordance with an embodiment of the invention, even if optionally only subliminally, is somewhat plastic and is colored with time changing distortions, which as recorded in images IM11*-IM15* provide an enhanced sense of depth when the images are viewed in sequence.

In some embodiments of the invention, features in a scene, such as scene 500, are imaged at different focal lengths to control relative velocity of the features in a sequence of images and depth perception of a motion sequence using the images. For example, velocity of a given feature relative to another feature in a scene may be increased or decreased by imaging the given feature at a larger focal length than the other feature.

In an embodiment of the invention the cameras with different focal lengths are spaced along the optic axis in a way which the inventors believe mimics the way a real image is imaged by the eye. In particular, at some focal length a given plane is imaged with a first lens in which the field of view forms an angle of α. For other focal lengths, which are meant to image different planes, the cameras are placed at positions along the axis at which their view angle views the same area of the particular plane.

Thus, in an embodiment of the invention the set of cameras spaced is along the optic axis—aiming at the same scene. By following the prescription of the previous paragraph, the focal length of each camera is adjusted to compensate for the relative scale change that occurs due to various distances of each particular camera from the scene. As a result—all cameras see the same scene, at the same scale—but with different focal lengths.

As every camera sees only one portion of the scene's depth, a picture composed from all “slices” (seen by the different axially spaced cameras) images the entire scene. Due to the fact when the cameras move laterally to the optic axis, the perspective change between scenes is enhanced, the resultant image series convey a significantly enhanced perception of depth significantly enhanced. This kind of depth enhancement caused by increased perspective changes between images is difficult if not impossible to achieve using any conventional lens with constant focal length, either in the physical or computer graphics world, using known methods.

While the above methodology is based on the inventors understanding of why this embodiment works, the inventors do not wish to be bound by the explanation, which has not been verified. The embodiment, however, has been found to provided an enhanced perception of a depth of field.

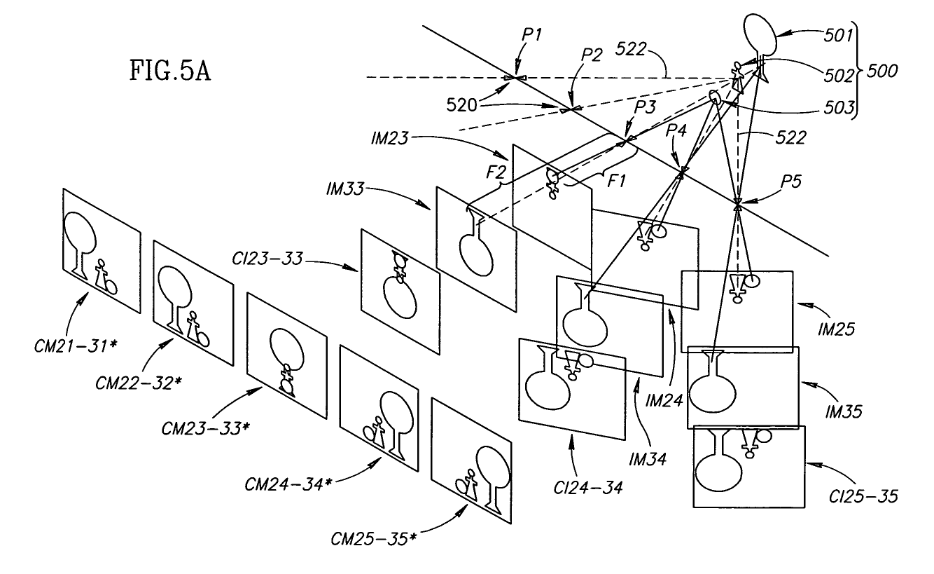

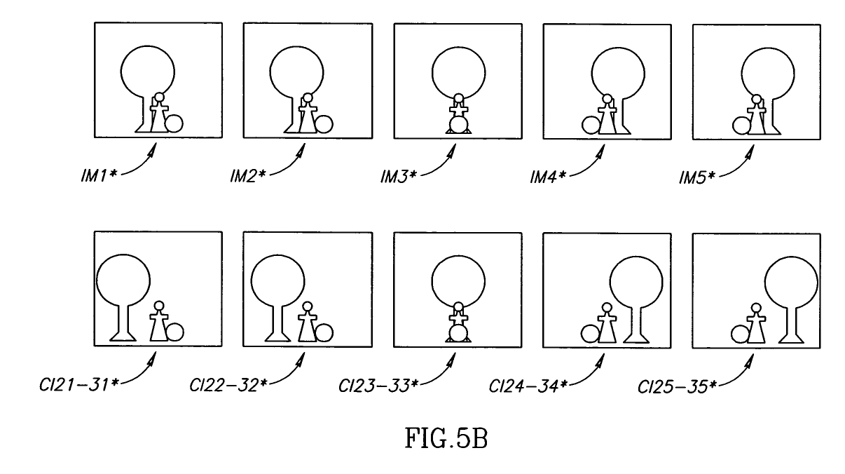

FIG. 5A schematically shows an effect of imaging different features in scene 500 at different focal lengths, in accordance with an embodiment of the invention. As in FIGS. 1A and 1B, in FIG. 5A camera 520 images scene 500 at locations P1-P5 along trajectory 530. However, at positions P1, P2, P3, P4 and P5, camera 520 images the girl and the ball in images IM21, IM22 . . . IM25 respectively at a focal length F1 and images tree 501 in images IM31, IM32 . . . IM35 respectively at a focal length F2. For convenience of presentation and to prevent clutter, only images IM23, IM24, IM25, IM33, IM34 and IM35 are shown in FIG. 5A. By way of example, F2 is greater than F1.

As a result, of imaging the tree at the greater focal length, the motion of the tree in images IM31 . . . IM35 is increased relative to the motion of the tree were it imaged at focal length F1 in images IM21 . . . IM25. Display images in accordance with an embodiment of the invention are formed by aligning and combining images IM21 . . . IM25 with images IM 31 . . . IM35 so that features in IM21 . . . IM25 overlay features in IM31 . . . IM35 to provide appropriate occlusion of farther features by nearer features. Combined images CI23-33, CI24-34, and CI25-35 are shown aligned behind the images from which they are formed, respectively IM23 and IM33, IM24 and IM34, and IM35 and IM36. Display combined images CI21-31*, CI22-32*, . . . CI25-35* shown in FIG. 5A correspond to combined images CI21-31, CI22-32, . . . CI25-35 turned right side up and reversed left to right.

FIG. 5B shows the combined display images CI21-31*, CI22-32*, . . . CI25-35* and images IM1*-IM5* acquired by prior art as illustrated in FIG. 1A so that the combined images in accordance with an embodiment of the invention may be readily compared with the prior art images. The images show that the relative motion between the tree and the girl and ball is substantially increased by imaging the tree at the longer focal length F2. The increased relative motion provides an enhanced perception of depth when the combined display images are displayed in a motion sequence compared to the depth perception provided by the prior art images IM1*-IM5*.

It will be understood that while the above explanation describes providing a sense of depth to objects that are stationary, the present invention is not limited to scenes in which all of the objects are stationary. In particular, moving objects will generally be provided with movement, such as described above, in addition to the “actual” movement of the object, based on its instantaneous layer position. Similarly, when a varying focal length camera is used to image the scene, the effect of the focal length will be changed to conform to the instantaneous position as changed by the actual movement of the object.

It will be further understood that the velocities and focal lengths can be adjusted either automatically or in response to a user input, via a mouse of the like.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method of generating a visual display of a scene having a desired illusion of depth comprising:
generating a sequence of display images of the scene;
setting velocities of features in the scene to generate non-perspective distortions of the scene in the display images; and
sequentially displaying the display images to both eyes of an observer.

2. A method of generating a visual display of a scene having an enhanced illusion of depth, comprising:
generating a sequence of images of the scene, each image being acquired for a different position relative to at least some of the features in the scene; and
sequentially displaying the display images to both eyes of an observer,
wherein generating said sequence includes:
setting positions of features in the scene in a systematic manner from image to image to generate non-perspective distortions of the images to provide an enhanced perception of depth to the sequence of images.

3. A method of generating a visual display of a scene having an enhanced illusion of depth, comprising:
generating a sequence of display images of the scene, each image being acquired by a virtual camera from a different position relative to at least some of the features in the scene; and
sequentially displaying the display images to both eyes of an observer,
wherein generating said sequence includes providing at least one feature in the scene with a velocity that generates relative motion between features, which in the scene are nominally stationary relative to each other, wherein a velocity provided to a feature of the at least one feature is a function of the features depth in the scene relative to the camera.

4. A method of generating a visual display according to claim 3 wherein the virtual camera positions lie along a non-planar three dimensional trajectory.

5. A method of generating a visual display according to claim 3 wherein the virtual camera positions lie along a planar trajectory.

6. A method of generating a visual display according to claim 3 wherein the virtual camera positions lie along a linear trajectory.

7. A method of generating a visual display according to claim 3 wherein some of the positions are closer to the scene than others.

8. A method of generating a visual display according to claim 3 wherein at least two positions are displaced from each other laterally relative to the scene.

9. A method of generating a visual display according to claim 3 wherein features at different depths relative to the camera are imaged at different focal lengths.

10. A method of generating a visual display according to claim 3 wherein the scene is partitioned into layers.

11. A method of generating a visual display according to claim 10 wherein a same velocity is set for features in a same layer.

12. A method of generating a visual display according to claim 10 wherein different velocities are set for different layers.

13. A method of generating a visual display according to claim 3 wherein at least one position of the virtual camera, the camera images different layers from different locations along the camera's optic axis.

14. A method of generating a visual display according to claim 3 wherein features that are closer to the camera are provided with a velocity in a first direction, features at an intermediate distance are stationary and wherein features at a farther distance are provided with a velocity in a second direction generally opposite to said first direction.

15. A method according to claim 14 wherein features that are closer to the camera are provided with a first velocity in a first direction, features at an intermediate distance are provided with a second velocity smaller than said first velocity in said first direction and features at very large distances are stationary.

16. A method according to claim 14 wherein features that are close to the camera are stationary, features at an intermediate distance are provided with a first velocity in a first direction and features at a farther distance are provided with a second velocity greater than said first velocity in said first direction.

17. A method according to claim 14 wherein said first direction is generally parallel to a direction of motion between said different positions.

18. A method according to any of claim 1 wherein moving features are provided with an additional velocity or change in position consistent with the change provided to correspondingly placed stationary objects.

19. A method of generating a visual display of a scene having an enhanced illusion of depth, comprising:
generating a sequence of display images of the scene, each display image being acquired by a virtual camera from a different position relative to at least some of the scene's features; and
sequentially displaying the display images to both eyes of an observer,
wherein a focal length at which the virtual camera images a feature in the scene is a function of the distance of the feature from the camera.

20. A method according to claim 19 wherein at least some features that are further from the camera are imaged with a focal length that is greater than a focal length used to image features that are relatively nearer to the camera.

21-23. (canceled)

24. A sequence of visual images suitable for viewing by both eyes of an observer in which an imaging position moves between images and in which stationary objects move with respect to each other between images dependent on a distance between the objects and imaging position.

25. A computer accessible storage medium encoded with a method in accordance with claim 1.

26. A computer accessible storage medium encoded with a method in accordance with claim 2.

27. A computer accessible storage medium encoded with a method in accordance with claim 3.

28. A computer accessible storage medium encoded with a method in accordance with claim 3.

29. A computer accessible storage medium encoded with a sequence in accordance with claim 3.
